(19) United States
(12) Patent Application Publication
(10) Pub. No.: US 2020/0189678 A1
(43) Pub. Date: Jun. 18, 2020

(54) Bicycle Safety Lighting Assembly

(71) Applicant: Gershon Phillip, Yonkers, NY (US)

(72) Inventor: Gershon Phillip, Yonkers, NY (US)

(21) Appl. No.: 16/224,470

(22) Filed: Dec. 18, 2018

(51) Int. Cl. B62J 6/00; B62J 6/04; B62J 6/02

(52) U.S. Cl. CPC B62J 6/005; B62J 6/02; B62J 6/04; B62J 6/003

(57) ABSTRACT

A bicycle safety lighting assembly for improved rider visibility and safety includes a front lighting array, a rear lighting array, and a control mechanism. The front lighting array is coupled to a front of a bicycle and comprises a running light, a headlight, and a pair of front turn signals. The rear lighting array is coupled to a back of the bicycle and comprises a brake taillight and a pair of rear turn signals. The control mechanism is coupled to a handle bar of the bicycle and comprises a housing, a battery coupled to the housing, a microprocessor, and a plurality of controls. The microprocessor is in operational communication with the battery and a brake system of the bicycle. The plurality of controls is coupled to the housing and is in operational communication with each of the microprocessor, the front lighting array, and the rear lighting array.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING ASSEMBLY

Not Applicable

### STATEMENT REGARDING PRIOR DISCLOSURES BY THE INVENTOR OR JOINT INVENTOR

Not Applicable

### BACKGROUND OF THE INVENTION

### (2) Description of Related Art Including Information Disclosed Under 37 CFR 1.97 and 1.98

The disclosure and prior art relates to bicycle lights and more particularly pertains to a new bicycle light for improved rider visibility and safety.

### BRIEF SUMMARY OF THE INVENTION

An embodiment of the disclosure meets the needs presented above by generally comprising a front lighting array, a rear lighting array, and a control mechanism. The front lighting array is configured to couple to a front of a bicycle and comprises a running light, a headlight, and a pair of front turn signals. The pair of front turn signals comprises a left front turn signal and a right front turn signal. The rear lighting array is configured to couple to a back of the bicycle and comprises a brake taillight and a pair of rear turn signals. The pair of rear turn signals comprises a left rear turn signal and a right rear turn signal. The control mechanism is configured to couple to a handle bar of the bicycle and comprises a housing, a battery coupled to the housing, a microprocessor, and a plurality of controls. The microprocessor is in operational communication with the battery and is configured to be in operational communication with a brake system of the bicycle. The plurality of controls is coupled to the housing and is in operational communication with each of the microprocessor, the front lighting array, and the rear lighting array.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric view of a bicycle safety lighting assembly according to an embodiment of the disclosure.

FIG. 2 is a side elevation view of an embodiment of the disclosure.

FIG. 3 is a rear elevation view of an embodiment of the disclosure.

FIG. 4 is a top plan view of an embodiment of the disclosure.

### DETAILED DESCRIPTION OF THE INVENTION

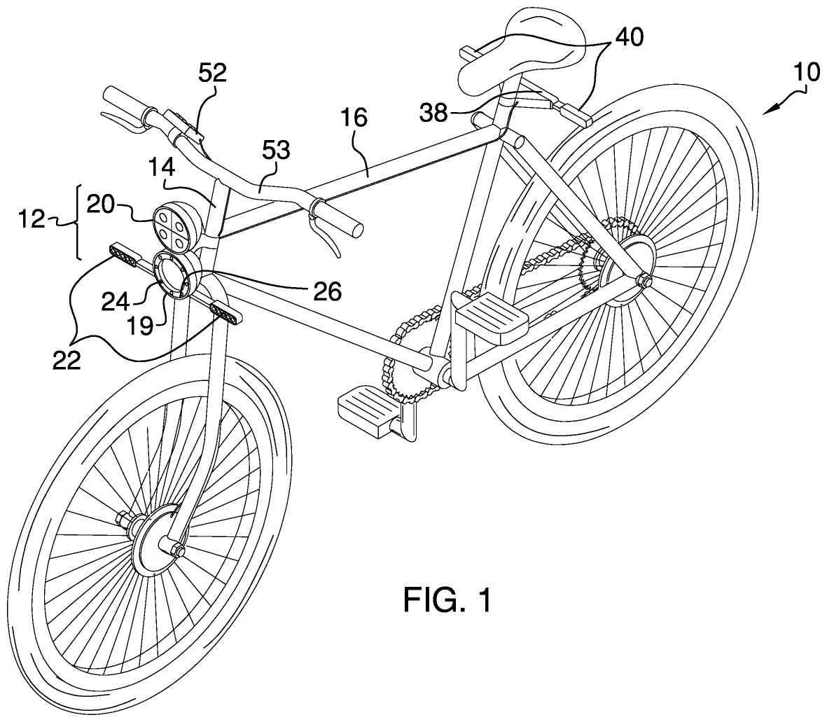

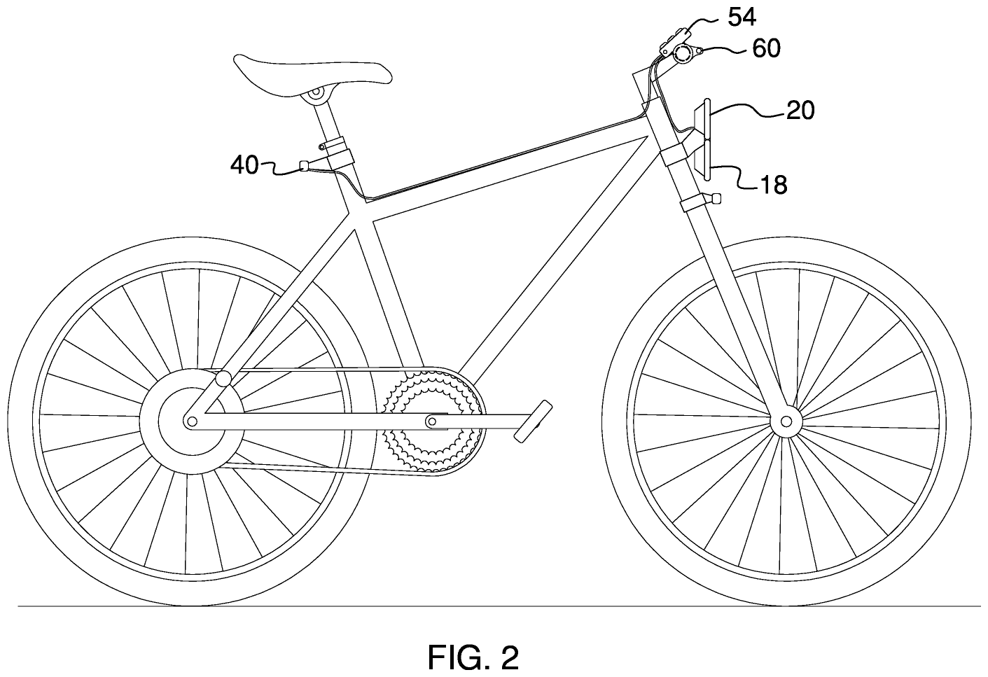

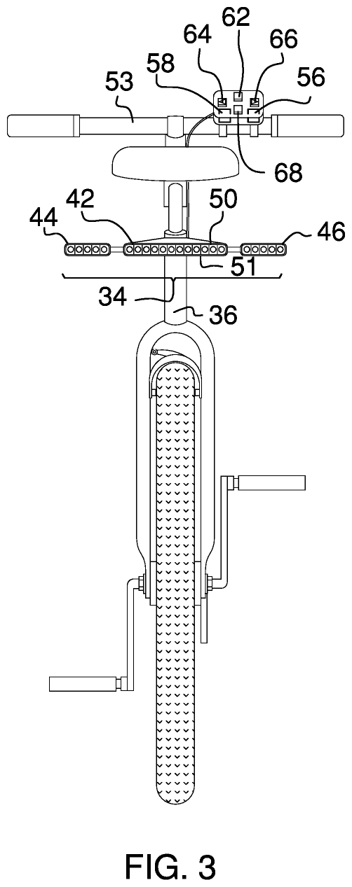

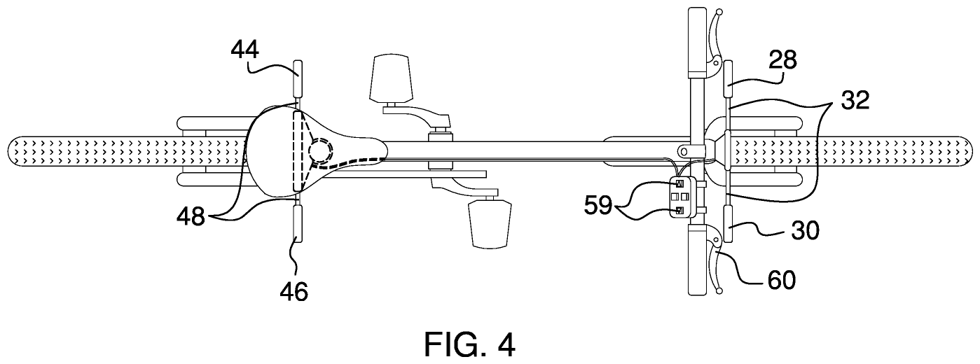

With reference now to the drawings, and in particular to FIGS. 1 through 4 thereof, a new bicycle light embodying the principles and concepts of an embodiment of the disclosure and generally designated by the reference numeral 10 will be described.

As best illustrated in FIGS. 1 through 4, the bicycle safety lighting assembly 10 generally comprises a front lighting array 12. The front lighting array 12 is configured to couple to a front 14 of a bicycle 16. The front lighting array 12 comprises a running light 18, a headlight 20, and a pair of front turn signals 22. The running light 18 may be a ring light 19 having a perimeter 24 and an LED ring 26 coupled to the perimeter 24. The headlight 20 is coupled above the running light 18. The pair of front turn signals 22 comprises a left front turn signal 28 and a right front turn signal 30. Each of the left front turn signal 28 and the right front turn signal 30 may have a front extension arm 32 colinearly extending from beneath the running light 18. A rear lighting array 34 is configured to couple to a back 36 of the bicycle. The rear lighting array 34 comprises a brake taillight 38 and a pair of rear turn signals 40. The brake taillight 38 may be a flasher light 42. The pair of rear turn signals 40 comprises a left rear turn signal 44 and a right rear turn signal 46. Each of the left rear turn signal 44 and the right rear turn signal 46 have a rear extension arm 48 colinearly extending from the brake taillight 38. Each of the pair of front turn signals 22 and the pair of rear turn signals 40 may be a flow light 50 having an LED row 51. The LED row 51 lights up directionally, or flows, to increase visibility and clarify its significance.

A control mechanism 52 is configured to couple to a handle bar 53 of the bicycle. The control mechanism 52 comprises a housing 54, a battery 56, a microprocessor 58, and a plurality of controls 59. The battery 56 and the microprocessor 58 are coupled to the housing 54. The microprocessor 58 is in operational communication with the battery 56 and is configured to be in operational communication with a brake system 60 of the bicycle to know when the brake system 60 is being activated by a rider. The microprocessor 58 is configured to change the brake taillight 38 from a flashing light to a solid brighter light when the brake system 60 of the bicycle is activated. The plurality of controls 59 is coupled to the housing 54 and is in operational communication with each of the microprocessor 58, the front lighting array 12, and the rear lighting array 34. The plurality of controls 59 may comprise a power button 62, a left turn signal control 64, a right turn signal control 66, and a headlight switch 68. The power button 62 is in operational communication with the battery 56. The left turn signal control 64 is in operational communication with each of the left front turn signal 28 and the left rear turn signal 44. The left turn signal control 64 illuminates and alternatively deactivates each of the left front turn signal 28 and the left rear turn signal 44. The right turn signal control 66 is in operational communication with each of the right front turn signal 30 and the right rear turn signal 46. The right turn signal control 66 illuminates and alternatively deactivates each of the right front turn signal 30 and the right rear turn signal 46. The headlight switch 68 is in operational communication with the headlight 20 to activate and alternatively deactivate the headlight 20.

In use, the power button 62 is activated before riding the bicycle 16. The running light 18 and the brake taillight 38 are then active for the duration of the ride, with the brake taillight 38 indicating when the brake system 60 is being activated by the rider. Before executing a turn, the rider uses either the left turn signal control 64 or the right turn signal control 66. For night riding, the headlight 20 may be activated using the headlight switch 68.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A bicycle safety lighting assembly comprising:
a front lighting array, the front lighting array being configured to couple to a front of a bicycle, the front lighting array comprising:
a running light, the running light being a ring light, the ring light having a perimeter and an LED ring coupled to the perimeter;
a headlight, the running light being mounted below the headlight; and
a pair of front turn signals, the pair of front turn signals comprising a left front turn signal and a right front turn signal;
a rear lighting array, the rear lighting array being configured to couple to a back of the bicycle, the rear lighting array comprising:
a brake taillight; and
a pair of rear turn signals, the pair of rear turn signals comprising a left rear turn signal and a right rear turn signal; and
a control mechanism, the control mechanism being configured to couple to a handle bar of the bicycle, the control mechanism comprising:
a housing;
a battery coupled to the housing;
a microprocessor, the microprocessor being in operational communication with the battery, the microprocessor being configured to be in operational communication with a brake system of the bicycle; and
a plurality of controls coupled to the housing, the plurality of controls being in operational communication with each of the microprocessor, the front lighting array, and the rear lighting array.

2. (canceled)

3. The bicycle safety lighting assembly of claim 1 further comprising each of the pair of front turn signals and the pair of rear turn signals having an extension arm.

4. The bicycle safety lighting assembly of claim 3 further comprising each of the pair of front turn signals and the pair of rear turn signals being a flow light.

5. The bicycle safety lighting assembly of claim 1 further comprising the brake taillight being a flasher light, the microprocessor being configured to change the brake taillight from a flashing light to a solid brighter light when the brake system of the bicycle is activated.

6. The bicycle safety lighting assembly of claim 3 further comprising the extension arm of each of the pair of rear turn signals colinearly extending from the brake taillight, the extension arm of each of the pair of front turn signals colinearly extending from beneath the running light.

7. The bicycle safety lighting assembly of claim 3 further comprising the plurality of controls comprising a power button, a left turn signal control, a right turn signal control, and a headlight switch, the power button being in operational communication with the battery, the left turn signal control being in operational communication with each of the left front turn signal and the left rear turn signal, the left turn signal control illuminating and alternatively deactivating each of the left front turn signal and the left rear turn signal, the right turn signal control being in operational communication with each of the right front turn signal and the right rear turn signal, the right turn signal control illuminating and alternatively deactivating each of the right front turn signal and the right rear turn signal, the headlight switch being in operational communication with the headlight, the headlight switch activating and alternatively deactivating the headlight.

8. A bicycle safety lighting assembly comprising:
a front lighting array, the front lighting array being configured to couple to a front of a bicycle, the front lighting array comprising:
a running light, the running light being a ring light, the ring light having a perimeter and an LED ring coupled to the perimeter;
a headlight, the running light being mounted below the headlight, the headlight being coupled above the running light; and
a pair of front turn signals, the pair of front turn signals comprising a left front turn signal and a right front turn signal, each of the left front turn signal and the right front turn signal having a front extension arm colinearly extending from beneath the running light;
a rear lighting array, the rear lighting array being configured to couple to a back of the bicycle, the rear lighting array comprising:
a brake taillight, the brake taillight being a flasher light; and
a pair of rear turn signals, the pair of rear turn signals comprising a left rear turn signal and a right rear turn signal, each of the left rear turn signal and the right rear turn signal having a rear extension arm colinearly extending from the brake taillight;
wherein each of the pair of front turn signals and the pair of rear turn signals is a flow light;
a control mechanism, the control mechanism being configured to couple to a handle bar of the bicycle, the control mechanism comprising:
a housing;
a battery coupled to the housing;
a microprocessor, the microprocessor being in operational communication with the battery, the microprocessor being configured to be in operational communication with a brake system of the bicycle, the microprocessor changing the brake taillight from a flashing light to a solid brighter light when the brake system of the bicycle is activated; and
a plurality of controls coupled to the housing, the plurality of controls being in operational communication with each of the microprocessor, the front lighting array, and the rear lighting array, the plurality of controls comprising a power button, a left turn signal control, a right turn signal control, and a headlight switch, the power button being in operational communication with the battery, the left turn signal control being in operational communication with each of the left front turn signal and the left rear turn signal, the left turn signal control illuminating and alternatively deactivating each of the left front turn signal and the left rear turn signal, the right turn signal control being in operational communication with each of the right front turn signal and the right rear turn signal, the right turn signal control illuminating and alternatively deactivating each of the right front turn signal and the right rear turn signal, the headlight switch being in operational communication with the headlight, the headlight switch activating and alternatively deactivating the headlight.

9. A bicycle and bicycle safety lighting system comprising:
a bicycle, the bicycle comprising a front, a back, a handlebar, and a brake system coupled to the handlebar;
a front lighting array, the front lighting array being coupled to the front of the bicycle, the front lighting array comprising:
a running light, the running light being a ring light, the ring light having a perimeter and an LED ring coupled to the perimeter;
a headlight, the running light being mounted below the headlight, the headlight being coupled above the running light; and
a pair of front turn signals, the pair of front turn signals comprising a left front turn signal and a right front turn signal, each of the left front turn signal and the right front turn signal having a front extension arm colinearly extending from beneath the running light;
a rear lighting array, the rear lighting array being coupled to the back of the bicycle, the rear lighting array comprising:
a brake taillight, the brake taillight being a flasher light; and
a pair of rear turn signals, the pair of rear turn signals comprising a left rear turn signal and a right rear turn signal, each of the left rear turn signal and the right rear turn signal having a rear extension arm colinearly extending from the brake taillight;
wherein each of the pair of front turn signals and the pair of rear turn signals is a flow light;
a control mechanism, the control mechanism being coupled to the handle bar of the bicycle, the control mechanism comprising:
a housing;
a battery coupled to the housing;
a microprocessor, the microprocessor being in operational communication with the battery, the microprocessor being configured to be in operational communication with a brake system of the bicycle, the microprocessor changing the brake taillight from a flashing light to a solid brighter light when the brake system of the bicycle is activated; and
a plurality of controls coupled to the housing, the plurality of controls being in operational communication with each of the microprocessor, the front lighting array, and the rear lighting array, the plurality of controls comprising a power button, a left turn signal control, a right turn signal control, and a headlight switch, the power button being in operational communication with the battery, the left turn signal control being in operational communication with each of the left front turn signal and the left rear turn signal, the left turn signal control illuminating and alternatively deactivating each of the left front turn signal and the left rear turn signal, the right turn signal control being in operational communication with each of the right front turn signal and the right rear turn signal, the right turn signal control illuminating and alternatively deactivating each of the right front turn signal and the right rear turn signal, the headlight switch being in operational communication with the headlight, the headlight switch activating and alternatively deactivating the headlight.
